(19) United States
(12) Patent Application Publication
(10) Pub. No.: US 2008/0258898 A1
(43) Pub. Date: Oct. 23, 2008

(54) Alarm system for Indicating Vehicle Running State

(76) Inventor: Chih-Chin YANG, SinJhuang City (TW)

Correspondence Address: SINORICA, LLC, 528 FALLSGROVE DRIVE, ROCKVILLE, MD, 20850, US

(21) Appl. No.: 12/061,691

(22) Filed: Apr. 3, 2008

(30) Foreign Application Priority Data
Apr. 19, 2007 (TW) 096206246

(51) Int. Cl. B60Q 1/26

(52) U.S. Cl. 340/468

(57) ABSTRACT

An alarm system for indicating vehicle running state comprises a main frame enclosed with a housing installed in a proper location of the vehicle body, and an accommodation space is formed between the main frame and its housing. A red, green and yellow light sources are installed on the main frame in the accommodation space. When the brake system is actuated, the red light source turns on. When the accelerator system is actuated the green light source turns on. In both brake system and accelerator system are not actuated, yellow light source turns on. With such variation of the light colors, the driver of the following rear vehicle may identify the instant driving condition of the preceding vehicle.

### BACKGROUND OF THE INVENTION

1. Field of the invention

The present invention relates to alarm system for indicating vehicle running state.

2. Description of the Prior Art

FIG. 1 is a perspective view of a vehicle alarm light system. Generally, a tail alarm light 70 or an additional alarm light 70 installed on the vehicle rear window(the third brake lamp) only has a warning effect with a red color light but without giving the following vehicle the information about instant running state of its own, such as the operating condition of the accelerator or the brake pedal.

In this decade, due to the rapid development of the high intensity LED, it has soon occupied the top seat of the automobile light source by its advantageous characteristics of rapid response, high reliability and long lifespan that helps it perform very successfully in keeping traffic security and curtailing the vehicle maintenance cost.

It is very popular nowadays to use LED in the tail light assembly and the direction lights. In addition to the aforesaid merits of improved traffic security and prolonged lifespan, the LED tail light assembly may substantially minimize the necessary space for installation due to its compactness in size and low heat generation resulting in possibility for expanding the trunk space.

### SUMMARY OF THE INVENTION

Accordingly, the gist of the present invention is directed to provide an alarm system for indicating vehicle running state with LED in which the aforesaid performance of the traditional vehicle tail lights may be more improved.

To achieve the above object, in one embodiment of the present invention, the alarm system comprises a main frame enclosed with a housing installed in a proper location of the vehicle body, and an accommodation space is formed between the main frame and its housing. A red light source, a green light source and a yellow light source are installed on the main frame in the accommodation space. The red light source is electrically connected to the vehicle brake system, the green one is electrically connected to the vehicle accelerator system, and the yellow one is directly connected to the control system. In this version, in case the vehicle brake is actuated, the red light source turns on, in case the vehicle accelerator is trod to operate, the green light source turns on. If the brake and the accelerator both remain inactuated, the yellow light source turns on. With such variation of the light colors, the driver of the following vehicle may identify the instant driving condition of the preceding vehicle.

These features and advantages of the present invention will be fully understood and appreciated from the following detailed description of the accompanying Drawings.

### BRIEF DESCRIPTION OF THE DRAWINGS

FIG. 1 is a perspective view of a conventional vehicle alarm light system.

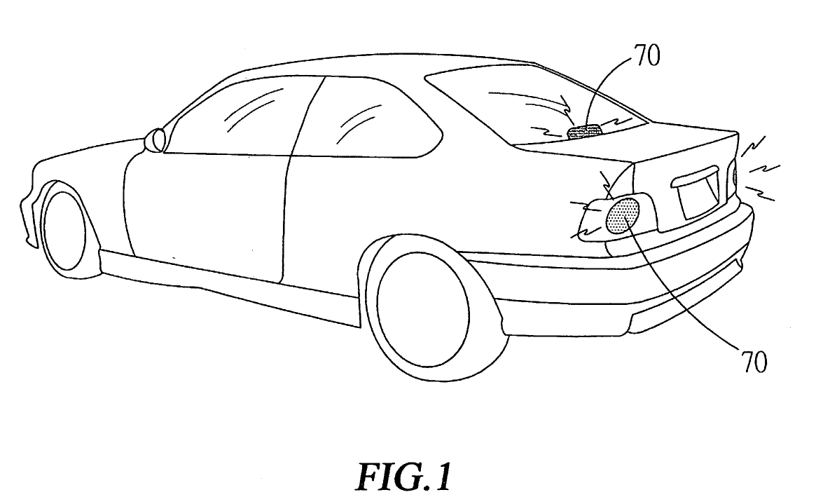

FIG. 2 is a perspective view of the vehicle alarm system applied in the tail lights according to a first embodiment of the present invention.

FIG. 3 is a rear view in a first embodiment of the present invention.

FIG. 4 is a schematic view showing a single LED is used to form the light source in the first embodiment shown in FIG. 3.

FIG. 5 is a schematic view showing a plurality of LEDs are used to form the light source in the first embodiment shown in FIG. 3.

FIG. 6(A) is a schematic view of the vehicle tail light system according to a second embodiment of the present invention.

FIG. 6(B) is a schematic view of the vehicle tail light system according to a third embodiment of the present invention.

FIG. 7 is a schematic view of the vehicle tail light system according to a fourth embodiment of the present invention.

FIG. 8 is a schematic view showing a plurality of LEDs are used to form the light source in the fourth embodiment shown in FIG. 7.

FIG. 9 is a perspective view of the vehicle alarm system installed on the rear window according to the present invention.

FIG. 10 is a perspective view of the vehicle alarm system installed along the rear number plate according to the present invention.

[Reference Numerals]

10:main frame 20:housing 30:accommodation space 40:red light source 41:red LED 42:first light group 43:second light group 44:third light group 50:yellow light source 51:yellow LED 60:greenlight source 61:green LED 62:fourth light group 63:fifth light group 64:sixth light group 70:alarm lamp

### DETAILED DESCRIPTION OF THE PREFERRED EMBODIMENT

Now the several embodiments of the present invention will be described in detail with reference to the accompanying drawings. It should be understood that the accompanying drawings are provided for purposes of reference and explanation, and shall not be construed as limitations applicable to the invention herein. Furthermore, throughout the description and drawings, like terms and reference numerals are used for designation of like or equivalent parts or portions, and redundant references will be omitted for simplicity of illustration and explanation.

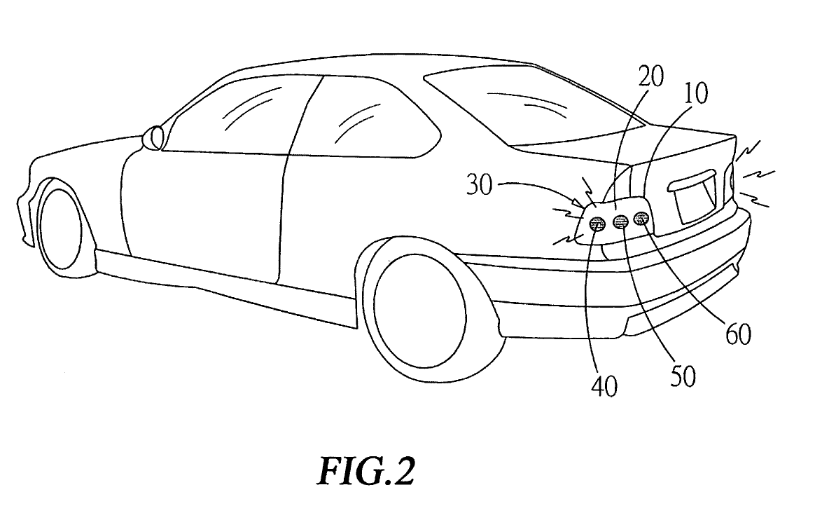

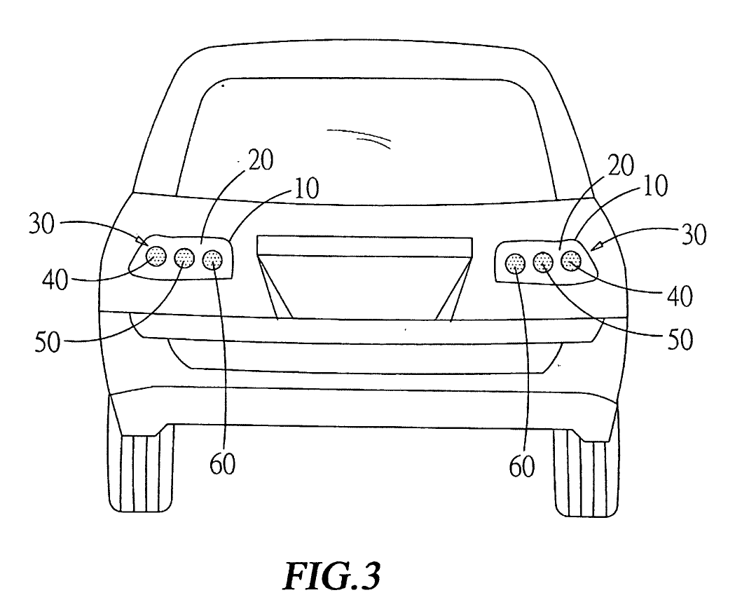

Referring to FIG. 2 and FIG. 3 which respectively express a perspective view of the vehicle alarm system applied in the tail lights and rear view thereof in a first embodiment of the present invention. As shown in FIGS. 2 and 3, a main frame 10 is installed at the vehicle's tail part, and the main frame 10 is enclosed with a housing 20. An accommodation space 30 is formed between the main frame 10 and the housing 20. On the main frame 10 in the accommodation space 30 there are installed a first, a second and a third light sources, wherein the first light source is for example, a red light source 40, the second one is a yellow light source 50 and the third one a green light source 60. In FIGS. 2 and 3, the three light sources 40, 50 and 60 are horizontally disposed, wherein with respect to the vehicle body, the red light source 40 is arranged at the outermost side, the green light source 60 occupies the innermost side, and the yellow light source 50 is interposed between the red and green light sources 40 and 60. However, the mode of arraying the light source may vary according to the actual requirement, horizontal arrangement is but one of the preferred examples.

In this embodiment, the color of each light source is used to represent the different states of the running vehicle. For example, the red light source 40 which being electrically connected to the brake system of the vehicle is used to show the working condition of the brake system, and the red light source 40 is actuated to flicker when the brake pedal is trod. The green light source 60 which being electrically connected to the accelerator of the vehicle is used to show the working condition of the accelerator. The yellow light source 50 which being directly connected to the control system of the vehicle is used to show that the vehicle is in the stop state when the light is turned on. The means for electrical connection is a conventional technique known to those skilled in the arts so that it is not necessary to be illustrated herein. In all, when the brake system is actuated, the red light source 40 turns on; when the accelerator is trod, the green light source 60 turns on; if both brake system and the accelerator stop working, the yellow light source 50 turns on. In this manner, the variation of the light color can show the instant state of the vehicle thereby warming the following vehicle in the rear side to respond relevantly in the critical occasion.

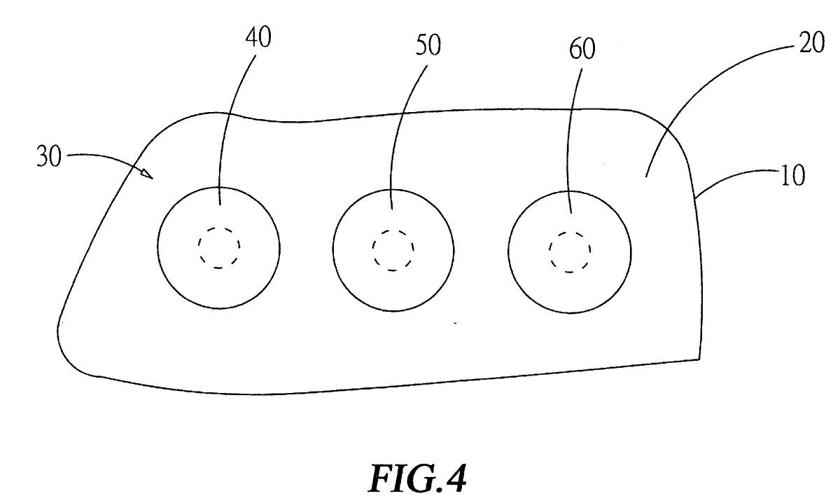

Referring to FIG. 4, The red, yellow and green light sources 40, 50 and 60 are respectively formed of a single LED, that is to say, the red, yellow and green light sources 40, 50 and 60 are respectively formed of one red LED 41, one yellow LED 51 and one green LED 61.

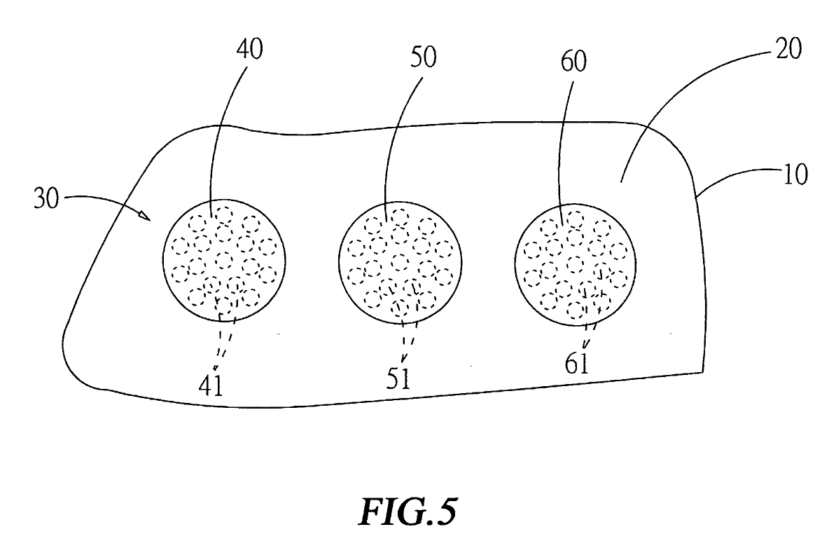

One the other hand, as shown in FIG. 5, the red, yellow and green light sources 40, 50 and 60 are respectively formed of a plurality of red LEDs 41, yellow LEDs 51 and green LEDs 61.

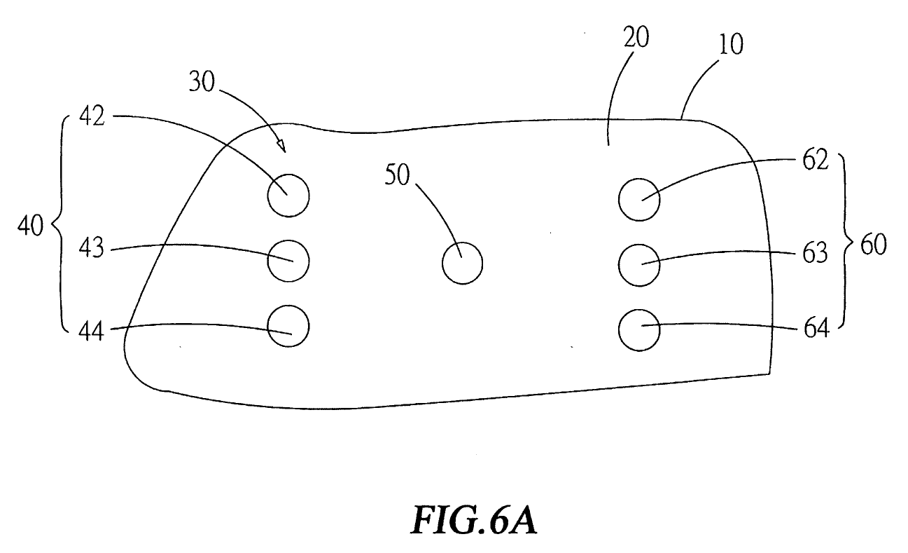

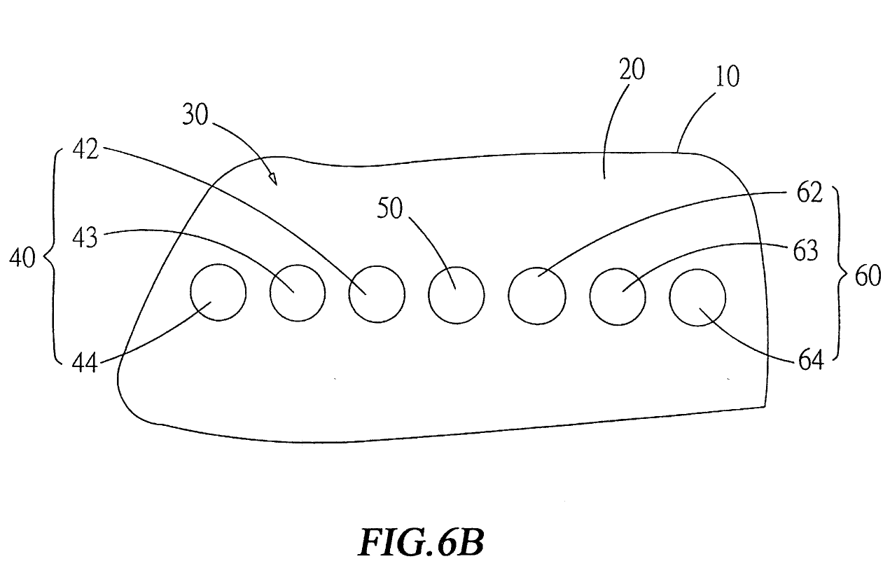

In the present invention, a variety of different colored light sources may be employed to indicate the instant state of vehicle more detailedly. Referring to FIG. 6(A), in a second embodiment, a plurality of red light sources 40, a plurality of green light sources 60 and a single yellow light source 50 are included. As shown in FIG. 6, the red light source 40 is formed of three vertically interposed first light group 42, second light group 43 and third light group 44, and the green light source 60 is formed of three vertically interposed fourth light group 62, fifth light group 63 and sixth light group 64. With this scheme a gradual alarming effect can be implemented. For example, if only one light group in the red light source 40, say, the first light group 42 turns on, it indicates that the brake system is slightly actuated (the brake pedal is trod weakly). In case all of the first, second and third light groups 42, 43 and 44 turn on, it indicated that the brake system is fully actuated as that in the case of emergency halting by treading the brake pedal forcibly. In this manner the driver of the following vehicle can clearly know about the moving state of the preceding vehicle according to variation of its red light source 40 so as to make a necessary response. The green light source 60 disposed opposite to the red light source 40 performs in the same manner as that of the latter, but it indicates the operation of the accelerator. Besides, the yellow light source 50 indicates merely a single state in which neither the accelerator nor the brake is actuated so that it is not necessary to install a plurality of light source to display gradual variation. In the present embodiment, only one yellow light source 50 is employed, and the red light source 40(first, second and third light groups 42, 43 and 44), the green light source 60(fourth, fifth and sixth light groups 62, 63 and 64), and the yellow light source 50 can be formed of single LED or plural LEDs as that in the first embodiment.

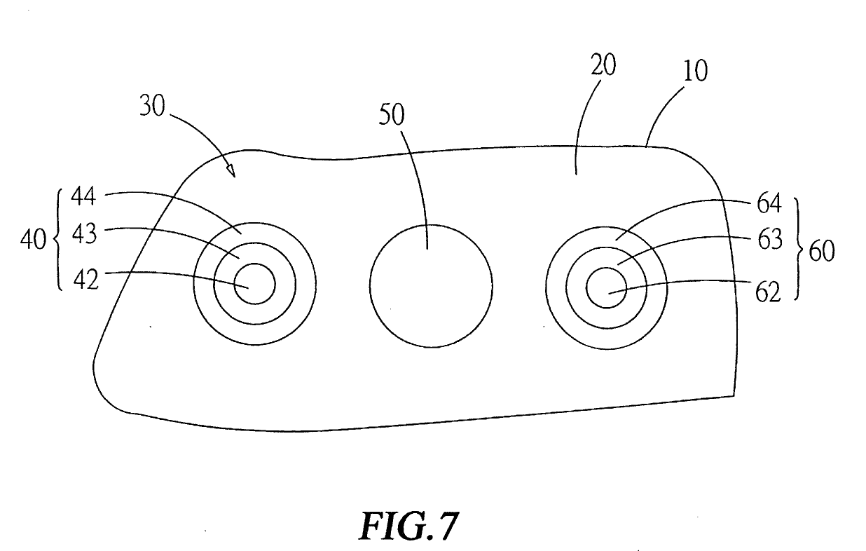

Other than vertical arrangement as that is shown in the second embodiment, the plural light sources can be horizontally disposed in a third embodiment shown in FIG. 6(B). In a fourth embodiment shown in FIG. 7, the first, second and third light groups 42, 43 and 44 of the red light source 40, and the fourth, fifth, and sixth light groups 62, 63 and 64 of the green light source 60 are coaxially disposed. Take red light source for example when the first light group 42 located in the center portion of the red light source 40 turns on, it indicates that the brake system is slightly actuated (the brake pedal is trod weakly). In case all of the first light group 42(center portion), the second light group 43(the second ring), and the third light group 44(the outermost ring) turn on, it indicates that the brake system is fully actuated as that in the case of emergency halting by treading the brake pedal forcibly. In this manner the moving state of the vehicle can be identified.

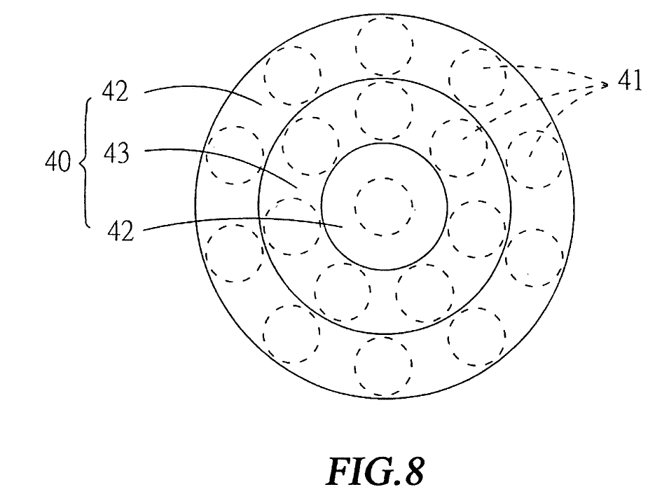

Referring to FIG. 8, the first, second and third light groups 42, 43 and 44 of the red light source 40 can be formed of single or plural red LEDs 41, and the same form of design is applicable to the yellow and green light sources 50 and 60.

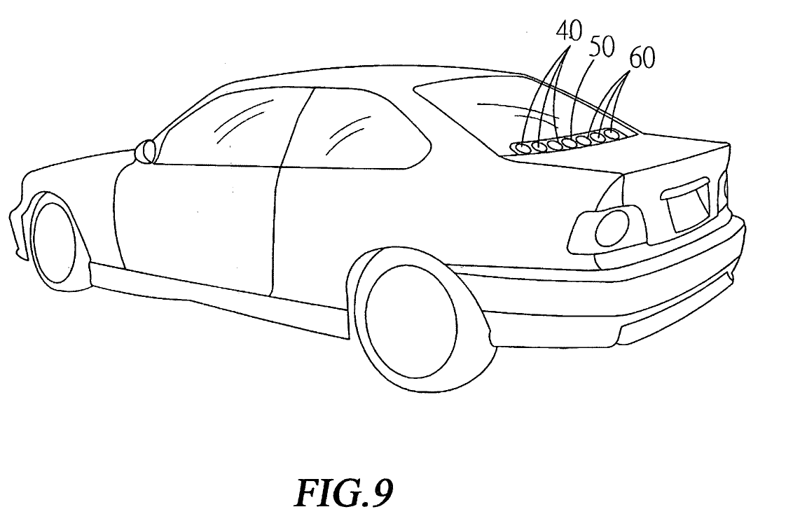

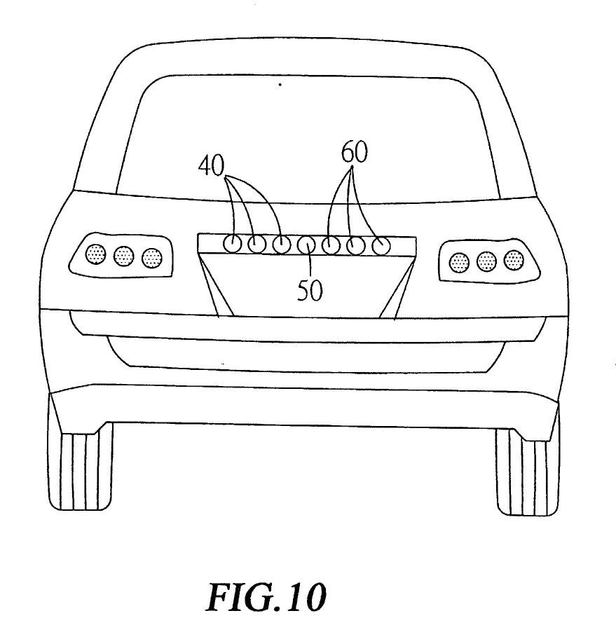

Other than installing at the rear of the vehicle as the tail lights (see FIG. 2), the alarm system of the present invention can also be installed on the rear window of the vehicle as shown in FIG. 9, or along the rear number plate as shown in FIG. 10.

In short, it emerges from the description of the above embodiments that the alarm system of the present invention has a noteworthy advantage that it can indicate vehicle running state to following vehicle in the rear more distinctly so as to avoid possible traffic accident.

It is apparent to a person skill in the art that the basic idea of the invention can be implemented in many different ways. The invention and its embodiments are thus not restricted to the examples described above, but may vary with the scope of the following claims.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An alarm system for indicating vehicle running state connected to vehicle accelerator system, brake system and control system comprising:
a main frame;
a housing enclosing said man frame;
an accommodation space formed between said main frame and said housing;
a first light source installed on said main frame in said accommodation space and being electrically connected to said brake system;
a second light source installed on said main frame in said accommodation space and being directly connected to said control system; and
a third light source installed on said main frame in said accommodation space and being electrically connected to said accelerator system.

2. The alarm system of claim 1, wherein said first light source is a red color light source and is connected to said brake system.

3. The alarm system of claim 2, wherein said red color light source includes a red LED (light emitting diode).

4. The alarm system of claim 2, wherein said red color light source includes a plurality of red LEDs.

5. The alarm system of claim 1, wherein said second light source is a yellow color light source and is connected to said control system.

6. The alarm system of claim 5, wherein said yellow color light source includes a yellow LED.

7. The alarm system of claim 5, wherein said yellow color light source includes a plurality of yellow LEDs.

8. The alarm system of claim 1, wherein said third light source is a green color light source.

9. The alarm system of claim 8, wherein said green color light source includes a green LED.

10. The alarm system of claim 8, wherein said green color light source includes a plurality of green LEDs.

11. An alarm system for indicating vehicle running state connected to vehicle accelerator system, brake system and control system comprising;
a main frame;
a housing enclosing said main frame;
an accommodation space formed between said main frame and said housing;
a plurality of first light sources installed on said main frame in said accommodation space.
a second light source installed on said main frame in said accommodation space; and
a plurality of third light sources installed on said main frame in said accommodation space.

12. The alarm system of claim 11, wherein said first light source includes:
a first light group;
a second light group installed adjacent to said first light group; and
a third light group installed adjacent to said second light group.

13. The alarm system of claim 12, wherein said first, second and third light groups are vertically disposed in order.

14. The alarm system of claim 12, wherein said first, second and third light groups are horizontally disposed in order.

15. The alarm system of claim 12, wherein said first, second and third light groups are coaxially disposed.

16. The alarm system of claim 11, wherein said third light source includes:
a fourth light group;
a fifth light group installed adjacent to said fourth light group; and
a sixth light group installed adjacent to said fifth light group.

17. The alarm system of claim 16, wherein said fourth, fifth and sixth, light groups are vertically disposed in order.

18. The alarm system of claim 16, wherein said fourth, fifth and sixth light groups are horizontally disposed in order.

19. The alarm system of claim 16, wherein said fourth, fifth and sixth light groups are coaxially disposed.

20. The alarm system of claim 11, wherein said second light source includes a yellow LED.
